(19) United States
(12) Patent Application Publication
(10) Pub. No.: US 2013/0295463 A1
(43) Pub. Date: Nov. 7, 2013

(54) CATHODE MATERIAL FOR LITHIUM ION SECONDARY BATTERIES AND METHOD FOR PRODUCING SAME

(71) Applicants: Yuki Matsuda, Ome-shi (JP); Atsushi Nemoto, Ome-shi (JP)

(72) Inventors: Yuki Matsuda, Ome-shi (JP); Atsushi Nemoto, Ome-shi (JP)

(73) Assignee: SHOEI CHEMICAL INC., Tokyo (JP)

(21) Appl. No.: 13/978,588

(22) PCT Filed: Jan. 12, 2012
(86) PCT No.: PCT/JP2012/050417

§ 371 Date: Jul. 8, 2013

(30) Foreign Application Priority Data
Jan. 17, 2011 (JP) 2011-006604

(51) Int. Cl. H01M 4/583

(52) U.S. Cl. CPC H01M 4/583
USPC 429/231.8; 427/122

(57) ABSTRACT

A cathode material for a lithium ion secondary battery includes: a metal oxide as a cathode active material; and a carbon material which coats at least a part of a surface of a particle of the metal oxide, wherein the cathode material has hydrophilicity so as to be precipitated into pure water.

### TECHNICAL FIELD

The present invention relates to a cathode material for a lithium ion secondary battery and a method for producing the same.

### BACKGROUND ART

A lithium ion secondary battery is lightweight and has a large capacity in comparison with a conventional lead secondary battery and nickel-cadmium secondary battery, and is widely used as a power supply of an electronic device such as a mobile phone and a notebook-type personal computer. Recently, the lithium ion secondary battery has been started to be used also as a battery of an electric vehicle, a plug-in hybrid vehicle, an electric motorcycle or the like.

The lithium ion secondary battery is basically composed of a cathode, an anode, an electrolyte, and a separator.

For the anode, there is used metal lithium, carbon and/or lithium titanate which can insert/extract lithium ions thereinto/therefrom, etc.

For the electrolyte, there are used: lithium salt; and an organic solvent or an ionizable liquid (ionic liquid) which is capable of dissolving the lithium salt thereinto.

The separator is disposed between the cathode and the anode to maintain insulation therebetween, and has fine pores through which the electrolyte can pass, for which separator porous organic resin, glass fiber, or the like is used.

The cathode is basically composed of active material capable of extracting/inserting the lithium ions therefrom/thereinto; a conductive additive for securing an electrical conduction path (electron conduction path) to a current collector; and a binding agent which binds the active material and the conductive additive to each other. As the conductive additive, a carbon material such as acetylene black, carbon black and graphite is used. As the active material which is a cathode material, a metal oxide of lithium and transition metal, such as LiCoO₂, LiNiO₂, LiNi_{0.8}Co_{0.2}O₂ and LiMn₂O₄, is used in general. Besides, there are: LiMPO₄ and derivatives obtained by the elemental substitution and the composition change of the lithium metal phosphate which is of a basic structure; Li₂MSiO₄ and derivatives obtained by the elemental substitution and the composition change of the lithium metal silicate which is of a basic structure; and LiMBO₃ and derivatives obtained by the elemental substitution and the composition change of the lithium metal borate which is of a basic structure. Here, M mainly includes a transition metal element such as Fe, Mn, Ni and Co, in each of which a valence is changed. In general, electron conductivity of such metal oxide is low, and accordingly, in the cathode which has the metal oxide as active material, the conductive additive is mixed as mentioned above. Moreover, further improvement of the electron conductivity in the cathode is also performed by performing carbon coating onto a surface of the metal oxide as the active material and bonding of carbon particles and carbon fiber onto the surface concerned in addition to the mixing of the conductive additive (Patent Literatures 1 to 6, Non-Patent Literature 1). In particular, in a metal oxide in which the electron conductivity is remarkably poor, it is insufficient if only the cathode is composed by simply allowing the conductive additive to coexist therein, and excellent battery property is not obtained, and accordingly, the metal oxide is used while the surface thereof is being subjected to the carbon coating.

### PRIOR ART LITERATURES

### Patent Literatures

Patent Literature 1: Japanese Patent Laid-Open Publication No. 2003-34534
Patent Literature 2: Japanese Patent Laid-Open Publication No. 2006-302671
Patent Literature 3: Japanese Patent Laid-Open Publication No. 2002-75364
Patent Literature 4: Japanese Patent Laid-Open Publication No. 2003-272632
Patent Literature 5: Japanese Patent Laid-Open Publication No. 2004-234977
Patent Literature 6: Japanese Patent Laid-Open Publication No. 2003-59491
Patent Literature 7: Japanese Patent Laid-Open Publication No. 2009-70666

### Non-Patent Literature

Non-Patent Literature 1: J. Moskon, R. Dominko, R. Cerc-Korosec, M. Gaberscek, J. Jamik, J. Power Sources 174, (2007) 638-688.

### SUMMARY OF INVENTION

### Problem to be Solved by Invention

As mentioned above, in the lithium ion secondary battery, there is a case where the surface of the metal oxide as the active material is coated with, the carbon material, and heretofore, it has been thought that a highly conductive one is preferable as the carbon material for use in the coating. For example, Patent Literature 2 describes that a carbon material is preferable, in which a content ratio of black lead (graphite) and/or conductive carbon (carbon having a graphite structure, which is defined as crystalline carbon in Patent Literature 2) is large. Patent Literature 3 describes that a carbon material is suitable, in which a proportion of carbon having a distorted structure and lowered symmetry (carbon in which a structure is broken by a strong mill such as a planetary ball mill and amorphization advances) is high.

Moreover, as shown in Patent Literatures 2 and 4, it has been thought that, preferably, the surface of the metal oxide is coated with carbon as much as possible, and most preferably, is completely coated therewith. Patent Literature 5 also describes that, preferably, 50 percent or more of a surface of an active material particle is coated with carbon. Note that, while Patent Literature 5 describes that a coating ratio of the carbon material is not 100 percent, but preferably, 50 percent or more to 90 percent or less (more preferably, 50 percent or more to 75 percent or less). Patent Literature 5 describes that this is because discharge property is lowered if the coating ratio becomes higher than such upper limit.

Furthermore, Patent Literature 6 describes that it is necessary to leave a surface of the active material, which is not covered with carbon black, since conduction of lithium ions is lowered in accordance with means for coating the surfaces of the active material with carbon black. It describes that carbon coating is performed, in which carbon fibers are impregnated, in order to control a surface state of whether or not the active material is coated. It also describes that, if the carbon fiber is used, it is possible to connect a plurality of the active material particles to one another by the carbon fiber, and a long conduction path is formed, and that the lithium ions easily move through an exposed surface of the active material, in which the carbon fibers are not impregnated, resulting in that high lithium ion conductivity can be ensured.

However, as a result that the inventors of the present invention investigated the carbon coating for the active material in detail, it has been found that excellent battery property is not always obtained by the conventional carbon coating. Concretely, as the carbon material which coats the active material, material having a graphite skeleton as a structure with good conductivity is used in general; however, a graphite skeleton surface has hydrophobicity. Meanwhile, a polar organic solvent is used as an electrolyte solvent in the lithium ion secondary battery, and it was found that a structure in which the surfaces of the active material are coated with a carbon material having a high proportion of the graphite skeleton has a problem that it is difficult for an electrolyte solution to penetrate into details of a porous structure of the cathode. Even if the black lead (graphite) is fractured so that the graphite structure is broken and the amorphization advances as described in Patent Literature 3, such permeability of the electrolyte solution is not improved since the hydrophobicity still remains. When the electrolyte solution does not penetrate into the details of the electrode as described above, a contact between the active material and the electrolyte solution is not efficient, and the active material in the cathode cannot be utilized effectively, and accordingly, for example, the battery property such as a capacity will not be improved consequently.

In addition, if the surfaces of the active material are coated with a larger amount of the hydrophobic carbon as described in Patent Literatures 2, 4 and 5, it becomes further difficult for the electrolyte solution to penetrate into the details of the cathode. Also in Patent Literature 6, because of using the carbon fiber in which the graphite skeleton has developed so that hydrophobicity is increased, it becomes difficult for the electrolyte solution to penetrate into the details of the cathode.

Meanwhile, by Patent Literature 7, there is known a method for producing lithium iron phosphate powder, which contains carbon, by converting a mixed solution, which contains a carbon compound, into mist, followed by thermal decomposition. However, the thermal decomposition is performed at a temperature as high as 800 deg C., and accordingly, carbon hardly remains on surfaces of powder particles, and carbon-containing lithium iron phosphate powder, which is obtained as a final product by directly firing the powder particles in an argon-hydrogen atmosphere, becomes powder in which carbon is unevenly distributed in an inside (refer to Paragraph 0013).

The present invention has been made in consideration of the above-mentioned problem, and an object of the present invention is to provide a cathode material for a lithium ion secondary battery, in which a metal oxide as a cathode active material and porous carbon are compounded with each other, and by which a high discharge capacity is obtained with ease, and to provide a method for producing the cathode material.

### Means for Solving the Problems

The inventors of the present invention have found out that, when a cathode material is sufficiently hydrophilic so as to be precipitated in pure water, in which material a part of the surface of the metal oxide particle as a cathode active material is coated with and compounded with a carbon material, a high discharge capacity is obtained with ease. It has been also found out that, more preferably, hydrophilic carbon is contained in a specific proportion in the carbon material contained in the cathode material. Because the carbon material is hydrophilic, it becomes easy for the electrolyte solution to penetrate into the details of the cathode, and the active material contained in the cathode functions efficiently and effectively.

Moreover, the inventors of the present invention have found out that, when at least a part of the carbon material becomes a bump-like form and the surface of the metal oxide is coated with such carbon mass in a specific proportion, a suitable electrode structure can be formed with ease and a high discharge capacity is obtained.

Furthermore, the inventors of the present invention have found out that, when the carbon material coating the metal oxide particles does not only coat the same but also establish a chemical bond on the interface between the carbon material and the metal oxide particles, then such high discharge capacity is obtained.

That is to say, the present invention is summarized as follows.

(1) A cathode material for a lithium ion secondary battery, including: a metal oxide as a cathode active material; and a carbon material which coats at least a part of a surface of a particle of the metal oxide, wherein the cathode material has hydrophilicity so as to be precipitated into pure water.
(2) The cathode material for the lithium ion secondary battery according to the above (1), wherein at least a part of the carbon material is a carbon mass in which carbon becomes a bump-like form, and 5 percent or more to less than 50 percent of the surface of the particle of the metal oxide is coated with the carbon mass.
(3) The cathode material for the lithium ion secondary battery according to the above (1) or (2), wherein at least a part of the carbon material has a hydrophilic functional group, and a content ratio of the carbon material having the hydrophilic functional group with respect to a total amount of the carbon material which coats the surface of the particle of the metal oxide is 20 to 40 percent.
(4) The cathode material for the lithium ion secondary battery according to the above (3), wherein the hydrophilic functional group is a functional group containing oxygen (O).
(5) The cathode material for the lithium ion secondary battery according to the above (3) or (4), wherein a content ratio of a carbon material having a graphite skeleton is 20 to 70 percent with respect to the total amount of the carbon material which coats the surface of the particle of the metal oxide.
(6) The cathode material for the lithium ion secondary battery according to any one of the above (3) to (5), wherein the content ratio V of the carbon material having the hydrophilic functional group is defined by a following formula (i):

V={(A−A_{SP2}−A_{SP3})/A}×100 (i)

where A is a peak area of C_{1S} measured by X-ray photoelectron spectroscopy of the carbon material, A_{SP2} is an SP² peak area occupying a part of the C_{1S} peak area, and A_{SP3} is an SP peak area occupying a part of the C_{1S} peak area.
(7) The cathode material for the lithium ion secondary battery according to any one of the above (1) to (6), wherein with regard to the metal oxide, a half width of a strongest diffraction peak in X-ray diffraction which takes Cu as a target is 0.2 degrees or less.
(8) A cathode material for a lithium ion secondary battery, including: a metal oxide particle as a cathode active material; a surface carbon layer which coats at least a part of a surface of the metal oxide particle and is chemically bonded to the metal oxide; and a bump-like carbon mass which coats a part of the surface of the metal oxide particle.
(9) The cathode material for the lithium ion secondary battery according to the above (8), further including an internal carbon layer to be bonded to the surface carbon layer, the internal carbon layer being provided in an inside of the metal oxide particle.
(10) The cathode material for the lithium ion secondary battery according to the above (8) or (9), wherein a thickness of the surface carbon layer is 2 nanometers or more to 10 nanometers or less.
(11) The cathode material for the lithium ion secondary battery according to any one of the above (8) to (10), wherein a coating ratio of the carbon mass with respect to the surface of the metal oxide particle is 5 percent or more to less than 50 percent.
(12) A method for producing a cathode material for a lithium ion secondary battery, comprising the steps of: turning a mixed solution into a liquid droplet, the mixed solution containing at least a lithium-containing compound and a carbon-containing compound; thermally decomposing the liquid droplet to generate an intermediate powder; and milling the intermediate powder; and annealing the milled intermediate powder, wherein the cathode material for the lithium ion secondary battery, in which at least a part of a surface is coated with a carbon material, is produced by the steps.
(13) The producing method according to the above (12), wherein the carbon-containing compound is at least one of ethylene glycol, triethylene glycol, polyvinyl alcohol, and glucose.

### Effect of Invention

In accordance with the present invention, a cathode material for a high-capacity lithium ion secondary battery can be obtained, whereby there can be obtained a cathode member for the high-capacity lithium ion secondary battery, and the high-capacity lithium ion secondary battery. In accordance with the production method of the present invention, the cathode material for the high-capacity lithium ion secondary battery can be obtained with ease.

### BRIEF DESCRIPTION OF DRAWINGS

FIG. 1 is an example where a cathode material is dispersed into pure water.

FIG. 2 is a schematic view of a cathode material of the present invention.

FIG. 3 is a schematic view of a conventional cathode material.

FIG. 4 is an example of a peak of C_{1S} by XPS and a peak separation thereof.

FIG. 5 is a TEM picture of the cathode material of the present invention.

FIG. 6 is a TEM picture of the cathode material of the present invention.

FIG. 7 is a schematic view showing a structure of the cathode material of the present invention.

### MODES FOR CARRYING OUT THE INVENTION

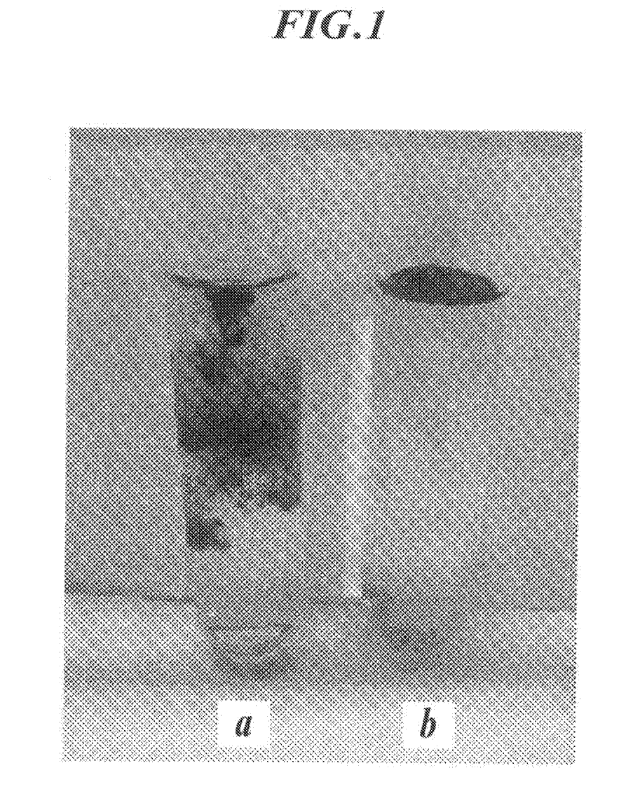

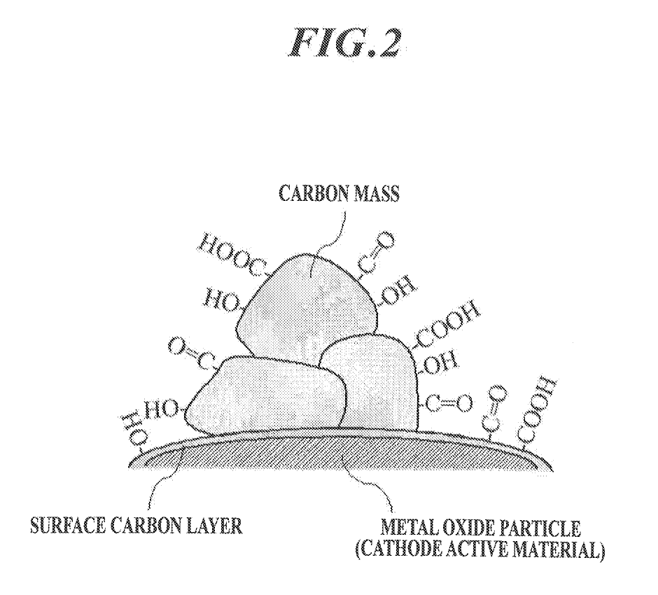

A cathode material for a lithium ion secondary battery according to the present invention includes: a metal oxide which is of a cathode active material; and a carbon material which coats at least a part of a surface of the metal oxide particle, and is easily dispersed into pure water as shown with reference character “a” in FIG. 1. In other words, the cathode material of the present invention is precipitated in pure water. Though details will be described later, this seems to be because, in the cathode material of the present invention, a large amount of carbon (hereinafter, “hydrophilic carbon”) bonded to hydrophilic functional groups is contained in the carbon material which coats the metal oxide. An example of a schematic view of a structure which is assumed with regard to the cathode material of the present invention is shown in FIG. 2. It seems that because the surface of the metal oxide particle as a cathode active material is coated (compounded) with the carbon material containing the hydrophilic carbon in the cathode material of the present invention, the cathode material has high wettability with respect to an electrolyte solvent (polar solvent) and an electrolyte solution can easily penetrate into details of a cathode in the case where the cathode material is used as the cathode, and accordingly an electrical property of high capacity can be obtained.

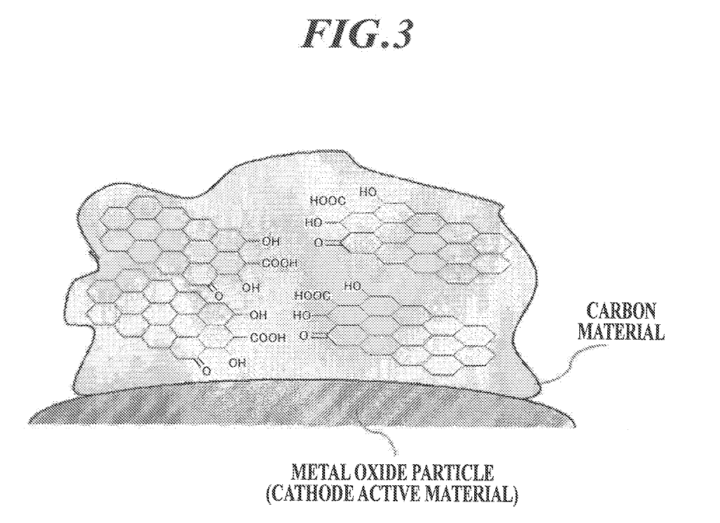

Meanwhile, as shown with reference character “b” in FIG. 1, when attempting to disperse a cathode material into pure water in a similar way, in which material metal oxide particles are coated with a carbon material having a graphite skeleton with good conductivity, the cathode material floats on a water surface, and is not dispersed. Thus, the cathode material coated with a carbon material including a high proportion of graphite skeleton carbon such as acetylene black, which is regarded heretofore as preferable, is hydrophobic as shown in FIG. 3. It is therefore assumed that because the cathode material has poor wettability with the electrolyte solution and it is difficult for the electrolyte solution to penetrate into the details of the cathode, the cathode material cannot be brought into efficient contact with the electrolyte solution and accordingly excellent property has not always been obtained.

In the present invention, preferably, a content ratio of the hydrophilic carbon contained in the carbon material which coats the surface of the metal oxide is 20 to 40 percent. If the content ratio of the hydrophilic carbon is less than 20 percent, the wettability with the electrolyte solution is low, and it becomes difficult for the electrolyte solution to penetrate into the details of the cathode. If the content ratio of the hydrophilic carbon exceeds 40 percent, electric conductivity becomes lower, and accordingly, it becomes difficult to obtain a high capacity with ease.

The functional groups owned by the hydrophilic carbon include elements which become polar groups, such as phosphorus (P), nitrogen (N), sulfur (S) and oxygen (O). In particular, the functional groups containing oxygen (O) are preferable. The oxygen contained in the hydrophilic functional groups can be confirmed by a variety of instrumental analyses methods. For example, there can be used the Nuclear magnetic resonance (NMR), the infrared spectroscopy (IR), the X-ray photoelectron spectroscopy (XPS) and the like. As the functional groups containing oxygen (O), there can be adopted —OH, —COOH, —C═O, —C—O—C—, and the like.

Moreover, a content ratio of the graphite skeleton carbon can be obtained by measurement of SP² carbon (graphite skeleton carbon) by the NMR, measurement of SP² carbon by the XPS, and/or measurement of a G peak (graphite skeleton carbon) by the Raman spectroscopy.

Hence, in the present invention, the content ratio V of the hydrophilic carbon in the carbon material refers to a value obtained by the following formula (i)

V={(A−A_{SP2}−A_{SP3})/A}×100 (i)

where A is a peak area of C_{1S} measured by the X-ray photoelectron spectroscopy of the carbon material, A_{SP2} is an SP² peak area occupying a part of the C_{1S} peak area, and A_{SP3} is an SP³ peak area occupying a part of the C_{1S} peak area.

With regard to the peak of C_{1S} measured by the XPS, the respective peak areas, which are calculated by performing peak separation at the SP² peak, the SP³ peak and two dummy peaks provided on a higher energy side than the SP³ peak, can be obtained. Values of the peak areas thus obtained are assigned to the above formula (i), whereby the content ratio V of the hydrophilic carbon is calculated.

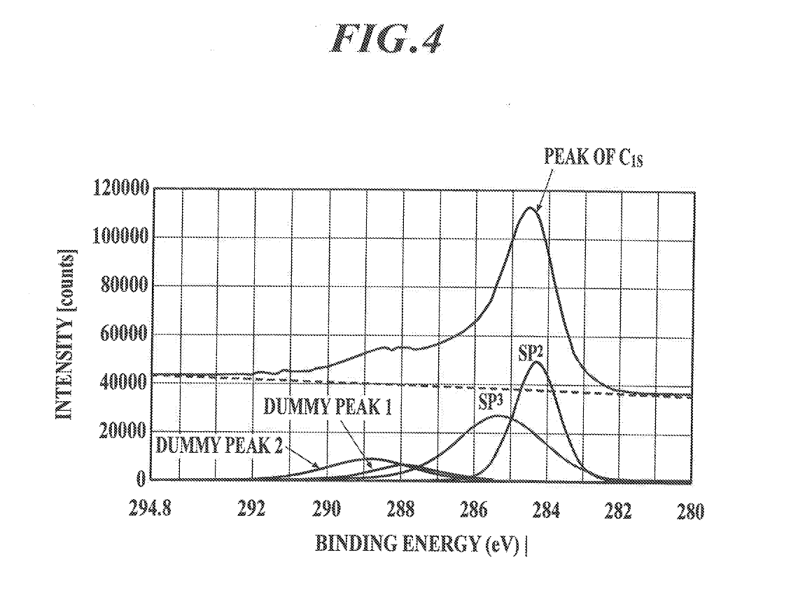

When the carbon material is measured by the X-ray photoelectron spectroscopy, then as shown in FIG. 4, the peak of C_{1S} is observed, and the peak concerned is usually composed of the SP² peak and the SP³ peak. Here, the SP² peak is derived from the graphite skeleton, and the SP³ peak is derived from a diamond skeleton. These peaks are inherent to carbon, and the present invention uses a carbon material in which a shoulder peak appears on a low binding energy side besides these peaks. The shoulder peak is derived from a hydroxyl group (—OH), a carboxyl group (—COOH), a carbonyl group (═C═O) and the like, which are functional groups contained by carbon skeleton binding, and these functional groups function as the hydrophilic functional groups. For example, a dummy peak 1 of FIG. 4 is allowed to be attributed to C of C—OH, and a dummy peak 2 is allowed to be attributed, to C of C═O and/or COOH. Hence, a carbon material having a shoulder peak of a specific size functions as the hydrophilic carbon material of the present invention.

With regard to the measurement of the carbon material by the X-ray photoelectron spectroscopy, binding energy (eV) takes a peak of gold (Au) 4f_{7/2} as a reference by measuring Au at the same time of measuring such measurement sample. That is to say, correction is performed while taking the peak as 84.0 eV. Moreover, with regard to the peak separation, first, a spectrum from which a background is removed is used. With regard to the SP² peak and the SP³ peak, the peak positions (binding energy) are fixed, and by using two dummy peaks as mentioned above, peak fitting is performed while defining these four peaks as a shape having a Gauss-Lorentz distribution. As for the SP² peak and the SP³ peak, the peak fitting is performed while fixing the peak positions and varying peak widths and peak heights thereof, and as for the two dummy peaks, the peak fitting is performed while varying peak positions, peak widths and peak heights thereof.

Moreover, in the present invention, preferably, the content ratio of the graphite skeleton carbon contained in the carbon material which coats the surface of the metal oxide is 20 to 70 percent. If the content ratio of the graphite skeleton carbon is less than 20 percent, then the electric conductivity of the carbon material is lowered, and it becomes difficult to obtain a high capacity. Meanwhile, if the content ratio of the graphite skeleton carbon exceeds 70 percent, hydrophobicity is increased, and it becomes difficult for the electrolyte solution to penetrate into the details of the cathode, and accordingly, it becomes difficult to obtain a high-capacity material.

The content ratio of the graphite skeleton carbon can be obtained from a ratio of A_{SP2}/A in the above-mentioned peak of the XPS. That is to say, such A_{SP2}/A ratio is 0.2 or more to 0.7 or less.

In the present invention, the matter that the metal oxide as the cathode active material and the carbon material are compounded with each other refers to a structure in which the particles of the metal oxide as the cathode active material and the carbon material are brought into contact with each other.

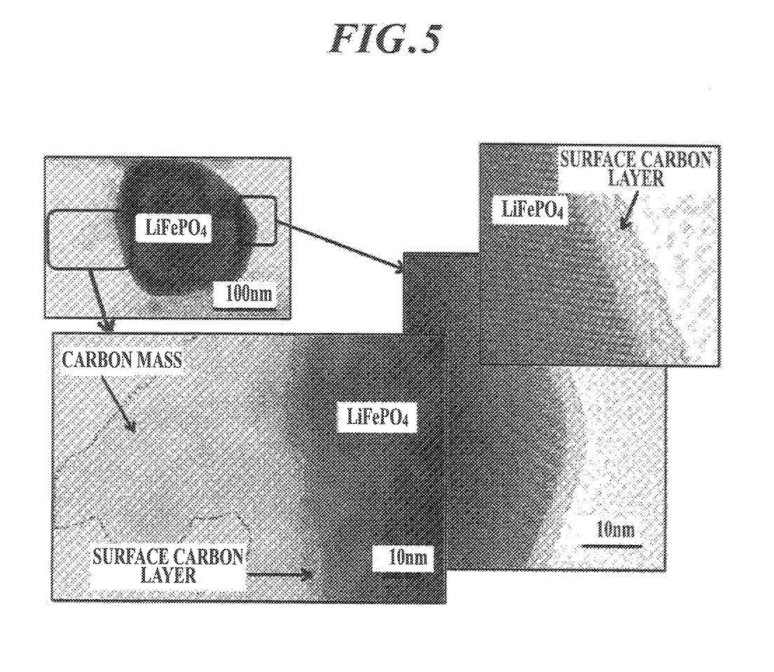

In the present invention, preferably, a part of the carbon material which coats the surface of the metal oxide particle has a structure, in which carbon becomes a bump like form (hereinafter, referred to as a “carbon mass”) and protrudes in a protrusion shape from the surface of the metal oxide particle. FIG. 5 shows a transmission electron microscope (TEM) picture showing a typical structure of the cathode material of the present invention. A sample shown in FIG. 5 has a structure in which the surface of the metal oxide (LiFePO₄) particle is coated with a thin carbon material layer (“surface carbon layer”) having a uniform thickness of 3 to 5 nanometers, and a carbon mass having a size of 20 to 100 nanometers is formed on a part of the surface of the metal oxide particle.

Here, more preferably, the surface carbon layer is thinner so that lithium ions easily penetrate the same. The lithium ions can penetrate the surface carbon layer when the thickness of the surface carbon layer is 50 nanometers or less; however, preferably, the thickness concerned is 2 nanometers or more to 10 nanometers or less. If the thickness is less than 2 nanometers, then the electron conductivity becomes sometimes poor though it becomes easy for the lithium ions to penetrate the surface carbon layer. If the thickness exceeds 10 nanometers, it sometimes becomes difficult for the lithium ions to penetrate the surface carbon layer.

In the present invention, preferably, 5 percent or more to less than 50 percent of the surface of the metal oxide particle is coated with the carbon mass. If such particle surface is coated with the carbon mass within this range, then an area where the surface of the cathode material and the electrolyte solution are brought into direct contact with each other can be ensured sufficiently. Accordingly, insertion/extraction of the lithium ions into/from the metal oxide can be performed efficiently, and it becomes easy to obtain a property of high capacity. In the case where such coating ratio is less than 5 percent, then a contact area of the particle surface with a conductive additive or a current collector through the carbon mass is reduced, and in some case, an electron conduction path cannot be ensured sufficiently, and the electron conductivity is not sufficient. Meanwhile, if the coating ratio becomes 50 percent or more, then the area where the surface of the cathode material and the electrolyte solution are brought into direct contact with each other is reduced, and in some case, it becomes impossible to efficiently perform the insertion/extraction of the lithium ions. More preferably, the coating ratio is 20 percent or more to 40 percent or less.

The proportion (coating ratio) in which the carbon mass coats the surface of the metal oxide particle in the present invention is defined by measuring a ratio of an area coated with the carbon mass with respect to a particle area of a projection image of the cathode material particle, which image is obtained by using a scanning electron microscope (SEM), repeatedly for each of 50 particles, to obtain an average value of the measured ratios as the proportion.

In the present invention, because the metal oxide particle as the cathode active material and the carbon material (surface carbon layer in particular) which coats at least a part of the surface of the metal oxide particle are chemically bonded to each other (FIG. 5), matching at the interface between the metal oxide and the carbon layer is enhanced, and interface resistance is reduced to bring excellent electron conductivity, and further, because of the structure having the above-mentioned carbon mass, it can be considered that an excellent electrode structure can be formed with ease, resulting in that a high discharge capacity is obtained.

The electrode of the lithium ion secondary battery generally has a configuration in which the cathode material, the conductive additive and a binding agent are combined with one another, and the conductive additive is used in the role of causing the cathode material to electrically connect to the current collector. Hence, it is important that the conductive additive is in contact with the cathode material so as to be electrically connected thereto. The cathode material of the present invention includes the carbon mass, is easy to contact the conductive additive, and can also increase the contact area therewith, and it can be considered that a good electrical connection is obtained for these reasons. Hence, preferably, the size of the carbon mass is larger than a thickness of the surface carbon layer.

In order to obtain the cathode material which has an excellent property, it is important that the metal oxide particle serving as the cathode active material forms a good electrical connection structure with respect to the current collector via the conductive additive, and it is particularly important that the carbon material contained in the cathode material is joined to the metal oxide particle by the chemical bond, and that the carbon material contained in the cathode material is in good contact with the conductive additive (as an example, that the contact area therebetween is large). In the conventional examples, cathode materials containing carbon materials have been known; however, there is none subjected to material design so that these conditions are satisfied, and therefore, contact resistance of the active material particle cannot be reduced, and it has been difficult to obtain excellent electrical property such as a high capacity.

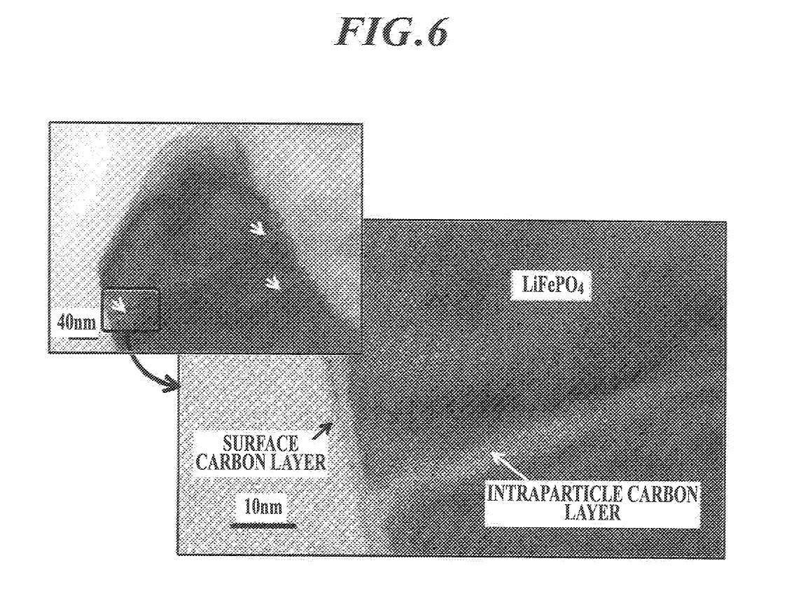

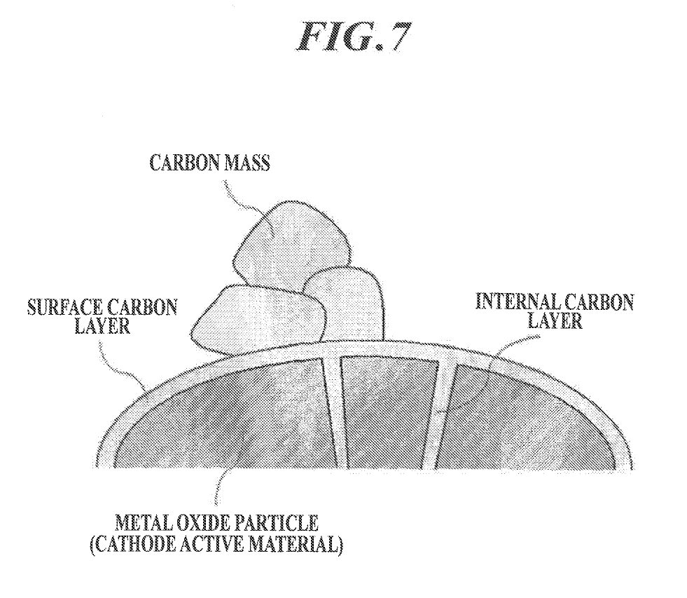

Moreover, as shown in a TEM picture of FIG. 6, in the cathode material of the present invention, a carbon layer (“internal carbon layer”) is observed in the inside of the metal oxide particle, and it can be confirmed that the internal carbon layer connects with the surface carbon layer. It can be considered that because the cathode material of the present invention has such structure, the electron conduction path can be ensured up to the inside of the metal oxide particle, it becomes easy for electrons to move following the insertion/extraction of the lithium ions in a region including the inside of the metal oxide particle, and this contributes to lowering of apparent electrical resistance of the cathode material. Hence, even when a particle diameter of the metal oxide particle is increased to some extent, it becomes easy to obtain a high capacity. FIG. 7 schematically shows the structure of the cathode material of the present invention, which is described above.

In the present invention, the metal oxide as the cathode active material is a metal oxide into/from which the lithium ions can be inserted/extracted, the ions being used in the cathode of the lithium ion secondary battery. For example, there can be adopted a multiple oxide of lithium and transition metal, such as LiCoO₂, LiNiO₂, LiNi_{0.8}Co_{0.2}O₂ and LiMn₂O₄. Besides, there can be adopted: LiMPO₄ and derivatives obtained by elemental substitution or composition change of the lithium metal phosphate which is of a basic structure; Li₂MSiO₄ and derivatives obtained by elemental substitution or composition change of the lithium metal silicate which is of a basic structure; and LiMBO₃ and derivatives obtained by elemental substitution or composition change of the lithium metal borate which is of a basic structure. Here, M mainly includes transition metal elements such as Fe, Mn, Ni and Co, in each of which a valence is changed. In particular, in the case where the present invention is applied to a cathode active material poor in electron conductivity, the functions/effects of the present invention can be enjoyed more significantly. As a preferable cathode active material in the present invention, for example, there can be adopted the metal oxide such as: LiMPO₄ and derivatives obtained by the elemental substitution and the composition change of the lithium metal phosphate which is of a basic structure; Li₂MSiO₄ and derivatives obtained by the elemental substitution and the composition change of the lithium metal silicate which is of a basic structure; and LiMBO₃ and derivatives obtained by the elemental substitution and the composition change of the lithium metal borate which is of a basic structure.

Preferably, the carbon material contained in the cathode material of the present invention is porous. When the carbon material compounded with the metal oxide as the cathode active material is porous, the electrolyte solution of the lithium ion secondary battery enters fine pores of the carbon material, and becomes easy to be brought into direct contact with the surface of the metal oxide. On the surface of metal oxide, with which the electrolyte solution is in direct contact, it becomes easy for the lithium ions in the electrolyte solution to enter the metal oxide, and it becomes easy for the lithium ions present in the metal oxide to be eluted into the electrolyte solution. When such porous carbon material is used in the present invention, in addition to the above-mentioned good wettability with respect to the electrolyte solution, permeation of the electrolyte solution is promoted, and it becomes easier for the electrolyte solution to penetrate into more details of the cathode, and accordingly, the use of the porous carbon material is preferable.

Here, the porous carbon material refers to a carbon material in which a capacity of fine pores with a diameter of 1.7 to 300 nanometers is 0.10 cm³/g or more. Such fine-pore capacity can be obtained by analyzing a measurement result, which is obtained at a nitrogen relative pressure of 0(zero) to 0.99 by the nitrogen adsorption method, by the BJH (Barrett, Joyner, and Halenda) method. The fine-pore capacity can be measured while separating only the porous carbon material; however, since the metal oxide serving as the cathode active material is not porous, the same value within an error range is obtained even when the porous carbon material is measured while leaving the porous carbon material compounded with the metal oxide. A porous carbon material with the fine-pore capacity of 0.15 cm³/g or more can obtain the functions/effects of the present invention more significantly. Moreover, there is no particular limitation on an upper limit of the fine-pore capacity; however, it sometimes becomes difficult to prepare a carbon material with the fine-pore capacity of 3.00 cm³/g or more.

Moreover, since the porous carbon material of the present invention is porous as described above, a BET (Brunauer, Emmett, Teller) specific surface area thereof is as large as 100 m²/g or more. In the case where measurement is performed for the cathode material in which the metal oxide as the cathode active material and the porous carbon material are compounded with each other, a BET specific surface area of the cathode material becomes 30 m²/g or more. Because the metal oxide is not porous, a BET specific surface area only of the metal oxide has a value as low as approximately 0.1 to 2.0 m²/g. Preferably, the BET specific surface area of the porous carbon is also large, more preferably, is 200 m²/g or more to 1000 m²/g or less. A value which is obtained by measuring the cathode material where the metal oxide as the cathode active material and the porous carbon material are compounded with each other is preferably 40 m²/g or more to 90 m²/g or less.

With regard to the metal oxide, a half width of a strongest diffraction peak in X-ray diffraction (XRD) which takes Cu (copper) as a target is preferably 0.20 degrees or less at 2 theta. The half width (half peak width) of the diffraction peak is an index which indicates a degree of crystallinity of a metal oxide, and accordingly, it is believed that a metal oxide with a smaller half width and higher crystallinity can obtain a higher capacity since the metal oxide can perform the insertion/extraction of the lithium ions with ease. Hence, when the half width is less than 0.20 degrees, it sometimes becomes impossible to obtain a high capacity since the crystallinity is insufficient. An upper limit of the half width is not particularly present; however, a half width obtained by measuring a (111) plane of a Si wafer, which is defined as an ideal half width of single crystal, is approximately 0.13 degrees, and accordingly, a half width with the above-mentioned value or more is not realistic.

There is no limitation on the particle diameter of the metal oxide in the present invention as long as, as the cathode active material, the metal oxide can perform the insertion/extraction of the lithium ions efficiently. However, for example, in the multiple oxide such as LiCoO₂, LiNiO₂, LiNi_{0.8}Co_{0.2}O₂ and LiMn₂O₄, whose electron conductivity is good, an average particle diameter is preferably 1 micrometer or more to 100 micrometers or less. Moreover, in the case of the metal oxide whose electron conductivity is not high, for example, such as LiMPO₄ and derivatives obtained by the elemental substitution and the composition change of the lithium metal phosphate which is of a basic structure, Li₂MSiO₄ and derivatives obtained by the elemental substitution and the composition change of the lithium metal silicate which is of a basic structure, and LiMBO₃ and derivatives obtained by the elemental substitution and the composition change of the lithium metal borate which is of a basic structure, a particle diameter is preferably 1 micrometer or less. A lower limit of the particle diameter of the metal oxide is not particularly present; however, a minimum unit at which the structure of the crystal can be maintained, for example, an approximate range of 5 to 10 nanometers becomes a substantially lower limit.

In the cathode material for the lithium ion secondary battery according to the present invention, a cathode layer containing at least a binding agent (also called a binder) is formed on a surface of metal foil, and the cathode material can be utilized as a cathode member for the lithium ion secondary battery. Moreover, in the cathode layer, a conductive additive can be contained according to needs.

The binding agent plays a role of binding the active material and the conductive additive to each other. The binding agent usable in the present invention is the one usually used in the event of preparing the cathode of the lithium ion secondary battery. Moreover, as the binding agent, the one is preferable, which is chemically and electrochemically stable to the electrolyte of the lithium ion secondary battery and the solvent thereof. The binding agent can be either thermoplastic resin or thermosetting resin. For example, there can be adopted: polyolefin such as polyethylene and polypropylene; fluorine resin such as polytetrafluaroethylene (PTFE), polyvinylidene fluoride (PVDF), a tetrafluoroethylene-hexafluoroethylene copolymer, a tetrafluoroethylene-hexafluoropropylene copolymer (FEP), a tetrafluoroethylene-perfluoroalkylvinylether copolymer (PFA), a vinylidene fluoride-hexafluoropropylene copolymer, a vinylidene fluoride-chlorotrifluoroethylene copolymer, an ethylene-tetrafluoroethylene copolymer (ETFE resin), polychlorotrifluoroethylene (PCTFE), a vinylidene fluoride-pentafluoropropylene copolymer, a propylene-tetrafluoroethylene copolymer, an ethylene-chlorotrifluoroethylene copolymer (ECTFE), a vinylidene fluoride-hexafluoropropylene-tetrafluoroethylene copolymer, and a vinylidene fluoride-perfluoromethyl vinyl ether-tetrafluoroethylene copolymer; styrene-butadiene rubber (SBR); an ethylene-acrylic acid copolymer or a Na⁺ ion-crosslinked body of the copolymer concerned; an ethylene-methacrylic acid copolymer or a Na⁺ ion-crosslinked body of the copolymer concerned; an ethylene-methyl acrylate copolymer or a Na⁺ ion-crosslinked body of the copolymer concerned; an ethylene-methyl methacrylate copolymer or a Na⁺ ion-crosslinked body of the copolymer concerned; carboxymethylcellulose; and the like. Moreover, these can also be used in combination of one another. Among these materials, PVDF and PTFE are particularly preferable. In the present invention, the binding agent can be used in a proportion of 0.1 to 20 percent by mass in a total amount of the cathode layer.

The conductive additive used in the present invention as necessary is not particularly limited as long as the conductive additive is a chemically stable electron conductive material substantially. For example, there can be adopted: carbon materials including: graphites such as natural graphite (flaky graphite) and artificial graphite; acetylene black; ketjen black; carbon blacks such as channel black, furnace black, lamp black, and thermal black; carbon fibers; and the like; as well as conductive fibers such as metal fiber; fluorocarbon; powders of metal such as aluminum; zinc oxide; conductive whiskers such as potassium titanate; conducive metal oxides such as titanium oxide; organic conductive materials such as a polyphenylene derivative; and the like. Each of these can be used singly, or two or more types thereof can be used simultaneously. Among them, the carbon materials such as acetylene black, ketjen black and carbon black are particularly preferable. In the present invention, the conductive additive can be used in a proportion of 0(zero) to 25 percent by mass.

In the present invention, the cathode layer contains at least the cathode active material and the binding agent of the present invention, and has an organization structure having a gap(s) which the electrolyte solution can enter.

The metal foil is conductive metal foil, and for example, foil of aluminum or an aluminum alloy can be used. A thickness of the foil can be set at 5 to 50 micrometers.

The lithium ion secondary battery can be configured by combining an anode, a separator and a non-aqueous electrolytic solution with the above-mentioned cathode material for the lithium ion secondary battery.

The anode is the one in which a binding agent is contained in an anode active material according to needs. The anode active material related to the anode just needs to be capable of doping/de-doping metal lithium or Li ions. As the one capable of doping/de-doping the Li ions, for example, there can be adopted carbon materials such as black lead, pyrolytic carbons, cokes, glassy carbons, sintered bodies of organic polymer compounds, meso-carbon microbeads, carbon fibers, and activated carbons. Moreover, as the anode active material, there can also be used compounds including: alloys of Si, Sn, In, etc.; oxides of Si, Sn, Ti, etc. which can be charged/discharged at a low potential approximate to that of Li; and nitrides of Li and Co, such as Li_{2.6}Co_{0.4}N. It is also possible to substitute a part of black lead with metal, oxide or the like, which can form an alloy with Li. In the case of using black lead as the anode active material, a voltage at the time of full charge can be regarded as approximately 0.1 volt with lithium taken as a reference, and accordingly, for the sake of convenience, a potential of the cathode can be calculated by a voltage obtained by adding 0.1 volt to a battery voltage. It therefore becomes easy to control, a charge potential of the cathode.

The anode can be formed into a structure in which an anode layer containing the anode active material and the binding agent is provided on a surface of metal foil serving as the current collector. As the metal foil, for example, there can be adopted foil of a simple substance of copper, nickel, or titanium, or an alloy of these, or stainless steel. As one of preferable materials of the anode current collector for use in the present invention, copper or an alloy thereof is adopted. As preferable metal which forms an alloy with copper, there are Zn, Ni, Sn, Al and the like; and besides, a small amount of Fe, P, Pb, Mn, Ti, Cr, Si, As or the like can be added.

The separator just needs to be an insulating thin film in which ion permeability is large and a predetermined mechanical strength is inherent, as a material thereof, there are used an olefin-based polymer, a fluorine-based polymer, a cellulose-based polymer, polyimide, Nylon, glass fiber, and alumina fiber, and as a form thereof, there are used nonwoven fabric, woven fabric, and a microporous film. In particular, as the material, preferable are polypropylene, polyethylene, a mixture of polypropylene and polyethylene, a mixture of polypropylene and polytetrafluoroethylene (PTFE), and a mixture of polyethylene and polytetrafluoroethylene (PTFE), and as the form, the microporous film is preferable. In particular, a microporous film is preferable, in which a pore diameter is 0.01 to 1 micrometers, and a thickness is 5 to 50 micrometers. Such microporous film can be a single film or a complex film made of two or more layers different in shape, density and the like of micropores and properties such as a material. For example, a complex film in which a polyethylene film and a polypropylene film are laminated to each other can be adopted.

In general, the non-aqueous electrolytic solution is composed of an electrolyte (supporting electrolyte) and a non-aqueous solvent. Lithium salt is mainly used as the supporting electrolyte in the lithium ion secondary battery. As the lithium salt usable in the present invention, for example, there can be adopted fluorosulfonic acid represented by LiClO₄, LiBF₄, LiPF₆, LiCF₃CO₂, LiAsF₆, LiSbF₆, LiB₁₀Cl₁₀, LiOSO₂CₙF₂ₙ₊₁ (n is a positive integer of 6 or less); imide salt represented by LiN(SO₂CₙF₂ₙ₊₁)(SO₂CₘF₂ₘ₊₁) (each of m and n is a positive integer of 6 or less); methide salt represented by LiC(SO₂CₚF₂ₚ₊₁)(SO₂C_{q}F_{2q+1})(SO₂CᵣF₂ᵣ₊₁) (each of p, q and r is a positive integer of 6 or less; and Li salt such as lower aliphatic carboxylic acid lithium, LiAlCl₄, LiCl, LiBr, LiI, chloroborane lithium, and 4-phenyl lithium borate. One type of these can be used, or two or more types of these can be mixed and used. Among them, one in which LiBF₄ and/or LiPF₆ are dissolved is preferable. A concentration of the supporting electrolyte is not particularly limited; however, 0.2 to 3 moles per liter of the electrolytic solution is preferable.

As the non-aqueous solvent, there can be adopted non-protic organic solvents and ionic liquids, which include propylene carbonate, ethylene carbonate, butylene carbonate, chloroethylene carbonate, trifluoromethyl ethylene carbonate, difluoromethyl ethylene carbonate, monofluoromethyl ethylene carbonate, methyl acetate hexafluoride, methyl acetate trifluoride, dimethyl carbonate, diethyl carbonate, methylethyl carbonate, γ-butyrolactone, methyl formate, methyl acetate, 1,2-dimethoxyethane, tetrahydrofuran, 2-methyltetrahydrofuran, dimethyl sulfoxide, 1,3-dioxolane, 2,2-bis(trifluoromethyl)-1,3-dioxolane, formamide, dimethylformamide, dioxolane, dioxane, acetonitrile, nitromethane, ethyl monoglyme, triester phosphate, boric acid triester, trimethoxymethane, a dioxolane derivative, sulfolane, 3-methyl-2-oxazolidinone, 3-alkylsydnone (alkyl group is a propyl, isopropyl, butyl group or the like), a propylene carbonate derivative, a tetrahydrofuran derivative, ethyl ether, 1,3-propane sultone, and the like. Each of these is used singly, or two or more types of these are mixed and used. Among them, carbonate-based solvents are preferable, and particularly preferably, cyclic carbonate and non-cyclic carbonate are mixed and used. As the cyclic carbonate, ethylene carbonate and propylene carbonate are preferable. Moreover, as the non-cyclic carbonate, diethyl carbonate, dimethyl carbonate and methyl ethyl carbonate are preferable. Furthermore, the ionic liquid is preferable from viewpoints of a wide electrochemical window and heat resistance.

As the electrolyte solution, an electrolyte solution is preferable, which contains LiCF₃SO₃, LiClO₄ LiBF₄ and/or LiPF₆ in an electrolytic solution mixed appropriately with ethylene carbonate, propylene carbonate, 1,2-dimethoxyethane, dimethyl carbonate or diethyl carbonate. In particular, an electrolyte is preferable, which contains LiPF₆ and at least one salt, which is selected from among LiCF₃SO₃, LiClO₄ and LiBF₄, in a mixed solvent of at least one of propylene carbonate and ethylene carbonate and at least one of dimethyl carbonate and diethyl carbonate. An additive amount of such electrolyte in the battery is not particularly limited, and the electrolyte can be used in response to amount of the cathode material and/or the anode material and to a size of the battery.

Moreover, besides the electrolyte solution, such solid electrolyte as follows can be used in combination. The solid electrolyte can be classified into an inorganic solid electrolyte and an organic solid electrolyte. As the inorganic solid electrolyte, nitrides, halides, oxoates of Li, and the like are adopted. Among them, Li₃N, LiI, Li₅N₁₂, Li₃N—LiI—LiOH, Li₄SiO₄, Li₄SiO₄—LiI—LiOH, ₓLi₃PO₄—₍₁₋ₓ₎Li₄SiO₄, Li₂SiS₃, a phosphorus sulfide compound and the like are effective.

In the organic solid electrolyte, polymer matrix materials are effective, which contain a polyethylene oxide derivative or a polymer containing the derivative concerned; a polypropylene oxide derivative or a polymer containing the derivative concerned; a polymer containing ionic dissociation groups; a mixture of the polymer containing the ionic dissociation groups and the above non-protic electrolytic solution; a phosphoric ester polymer; and a non-protic polar solvent. Moreover, there is also a method of adding polyacrylonitrile to the electrolytic solution. Moreover, a method of using the inorganic and organic solid electrolytes in combination is also known.

Moreover, in the present invention, the secondary battery can be directly manufactured by using the cathode material of the present invention without passing through a process of the cathode member. For example, the secondary battery can be composed in such a manner that the anode, the separator and the non-aqueous electrolytic solution are combined with a cathode in which a cathode layer containing the cathode material of the present invention, the conductive additive and the binding agent is formed on a metal mesh.

The lithium ion secondary battery cathode material of the present invention can be produced by the following method as an example.

The metal oxide as the cathode active material can be prepared by any method such as a dry method and a wet method as long as it is a method capable of synthesizing the oxide. For example, there can be adopted a solid phase method (solid phase reaction method), a hydrothermal method (hydrothermal synthesis method), a co-precipitation method, a sol-gel method, a vapor phase synthesis method (physical vapor deposition (PVD) method, chemical vapor deposition (CVD) method), a spray pyrolysis method, a flame spray pyrolysis method, a baking method, and the like.

A description is made below of examples of preparing the metal oxide by the solid phase method, the spray pyrolysis method, and the baking method.

As raw materials for use in the solid phase method, there are used compounds, each of which contains an element that composes the above-mentioned metal oxide, for example, an oxide, carbonate, organic salt such as acetate and oxalate, and the like. These compounds are weighed and mixed with one another in accordance with a composition ratio. For the above-mentioned mixing, a wet mixing method, a dry mixing method and the like are used. A mixture thus obtained is fired, whereby the metal oxide is synthesized. Metal oxide powder obtained by the firing is milled according to needs. In the case where unreacted substance remains, the mixture is further fired in some cases after the milling. In the case of LiMg₂O₄ as a specific example, for example, manganese dioxide powder and lithium carbonate powder are weighed and mixed with each other so as to achieve the above-mentioned chemical composition, and powder thus mixed is fired at 700 to 800 deg C. for 5 to 20 hours, whereby the LiMg₂O₄ concerned can be prepared. Moreover, in the case of LiFePO₄, for example, lithium carbonate, iron (II) oxalate dihydrate and diammonium hydrogen phosphate are weighed and mixed with one another so as to achieve the above-mentioned chemical composition, and powder thus mixed is fired at 600 to 900 deg C. for 5 to 20 hours in an argon flow, whereby the LiFePO₄ can be prepared.

As a raw material for use in the spray pyrolysis method, a compound is used, which contains elements composing the above-mentioned metal oxide, and is dissolved into water or an organic solvent. A solution having the above-mentioned compound dissolved thereinto is turned into liquid droplets by ultrasonic waves and a nozzle (two-fluid nozzle, four-fluid nozzle, and the like), and subsequently, the droplets are introduced into a heating furnace at a temperature of 400 to 1200 deg C., and are thermally decomposed, whereby the metal oxide can be prepared. According to needs, the metal oxide is further subjected to heat treatment and milling. Moreover, an organic compound (involved in the concept of the “carbon-containing compound” in this specification) is contained in a solution of the raw material, whereby the metal oxide containing the carbon material can be prepared. In the case of LiCoO₂ as a specific example, for example, lithium nitrate and cobalt nitrate are weighed so as to achieve the above-mentioned chemical composition, followed by dissolution into water. Here, an organic compound can be further added to the above-mentioned solution, and as the organic compound, there can be adopted ascorbic acid, monosaccharide (glucose, fructose, galactose and the like), disaccharide (sucrose, maltose, lactose and the like), polysaccharide (amylose, cellulose, dextrin and the like), polyvinyl alcohol, polyethylene glycol, polypropylene glycol, polyvinyl butyral, polyvinyl pyrrolidone, phenol, hydroquinone, catechol, maleic acid, citric acid, malonic acid, ethylene glycol, triethylene glycol, diethylene glycol butyl methyl ether, triethylene glycol butyl methyl ether, tetraethylene glycol dimethyl ether, tripropylene glycol dimethyl ether, glycerin, and the like. For example, a solution having the above-mentioned compound dissolved thereinto is turned into liquid droplets by an ultrasonic atomizer, and the liquid droplets are introduced into a heating furnace at a temperature of 500 to 800 deg C. while using air as carrier gas, followed by thermal decomposition, whereby the LiCoO₂ can be prepared. Moreover, in the case of LiMnPO₄, for example, lithium nitrate, manganese (II) nitrate hexahydrate, and phosphoric acid (85 percent aqueous solution) are weighed so as to achieve the above-mentioned chemical composition, followed by dissolution into water. For example, a solution having the above-mentioned compound dissolved thereinto is turned into liquid droplets, by an ultrasonic atomizer, and the liquid droplets are introduced into a heating furnace at a temperature of 500 to 900 deg C. while using nitrogen as carrier gas, followed by thermal decomposition, whereby the LiMnPO₄ can be prepared.

As a raw material for use in the baking method, a compound is used, which contains elements composing the above-mentioned metal oxide, and is dissolved into water. In the case of a metal oxide containing the iron element, preferably, an iron and steel pickling waste liquid is used as an iron source raw material as described in Japanese Patent Laid-Open Publication No. 2010-287050. It can be prepared in such a manner that a solution having the above-mentioned compound dissolved thereinto is introduced into a baking furnace of the Ruthner type, the Chemirite type or the like, followed by thermal decomposition. According to needs, it is further subjected to heat treatment and milling. In the case of LiNiO₂ as a specific example, for example, lithium acetate, nickel (II) nitrate hexahydrate are weighed so as to achieve the chemical composition concerned, followed by dissolution into water. A solution thus obtained is introduced, for example, into a baking furnace of the Chemirite type, and is thermally decomposed at a temperature of 500 to 800 deg C., whereby the LiNiO₂ can be prepared. Moreover, in the case of LiFePO₄, for example, lithium carbonate and phosphoric acid (85 percent aqueous solution) are dissolved into an iron and steel pickling waste liquid (for example, a hydrochloric acid waste liquid with a concentration of 0.6 mol (Fe)/liter)), and a concentration of a resultant solution is adjusted to that of the above-mentioned chemical composition ratio. Here, in a similar way to the case of the spray pyrolysis method as mentioned above, an organic compound can be added. Then, the obtained solution is introduced, for example, in the baking furnace of the Ruthner type, and is thermally decomposed at a temperature of 500 to 800 deg C., whereby the LiFePO₄ concerned can be prepared.

The compounding of the carbon material with the metal oxide (cathode active material), which is obtained as mentioned above, is performed as follows.

As the carbon material, a material which satisfies the requirements of the present invention can be selected for use from among materials such as black lead, acetylene black, carbon black, ketjen black, vapor-grown carbon fiber carbon nanotube, carbon nanohorn, fullerene, and activated carbon. Even a material, which does not satisfy the requirements of the present invention, can be turned to a material, which satisfies the requirements of the present invention, by controlling the content of the hydrophilic functional groups, for example, in such a manner that activation treatment such as alkali activation, steam activation, carbon dioxide activation, and zinc chloride activation is performed, and that heat treatment is performed in an inactive atmosphere, a reducing gas atmosphere, and/or an atmosphere containing oxidized gas. Each of these materials can be used singly or two or more types of these can be used in combination.

Then, the metal oxide and the carbon material can be compounded with each other by performing wet or dry mixing therefor. For the mixing, for example, there can be used a milling device and a mixing device, such as a ball mill, a planetary ball mill, a mortar, a beads mill, a vibration mill, a jet mill, a pin mill, a drum mixer, a vibration stirrer, a V-type mixer, and a rocking mixer. Moreover, they can be further subjected to heat treatment after they are formed into a compounded structure.

Besides, it is also possible to add an organic compound (carbon-containing compound) as a carbon source to the metal oxide powder and then perform heat treatment so that the organic compound is decomposed/carbonized and thereby they are compounded with each other. As the organic compound which is used as the carbon source, for example, there can be adopted polyethylene glycol, polypropylene glycol, polyethylene imine, polyvinyl alcohol, polyacrylic acid (polyacrylate), polyvinyl butyral, polyvinyl pyrrolidone, copolymers of these, or the like. Moreover, saccharides such as sugar alcohol, sugar ester and cellulose, or polyglycerin, polyglycerin ester, sorbitan ester, and polyoxyethylene sorbitan can be used. These carbon-containing compounds can be subjected to dry mixing with the metal oxide powder, and can also be dissolved into water, an organic solvent or the like, and then mixed with the metal oxide powder, it is also possible to make an organic compound, which is dissolved into water or the organic solvent among the organic compounds serving as the carbon sources, dissolved into water or the organic solvent, to add the metal oxide powder thereto to mix them with each other, to make the organic compound carried on the surface of the metal oxide by a drying method such as an evaporation-to-dryness method, a vacuum drying method, a spray dry method, and a freeze dry method, and to subsequently fire them at a temperature at which the organic compound is decomposed and the carbon material is generated, so that the metal oxide can be compounded with the carbon material. Although depending on a type of the organic compound for use, a firing temperature in this case is preferably 500 to 1000 deg C., more preferably, ranges from 700 to 800 deg C. At a temperature as low as less than 500 deg C., the decomposition of the organic compound is insufficient, generation of a good carbon material becomes insufficient, and good battery property cannot be obtained. Also at a high temperature exceeding 1000 deg C., it becomes impossible to obtain such good battery property.

Note that, in the present invention, preferably, a mixed solution containing at least a lithium-containing compound and the carbon-containing compound is turned into liquid droplets, the liquid droplets are thermally decomposed to prepare intermediate powder, and the intermediate powder is milled, followed by annealing treatment, whereby the cathode material is produced.

In such production method, the spray pyrolysis method, the flame spray pyrolysis method, the baking method, and the like, which are known in public, can be applied to the preparation of the intermediate powder. For example, as described in Japanese Examined Patent Publication No. S63-31522; Japanese Patent Laid-Open Publication No. H6-172802, Japanese Patent Laid-Open Publication No. H6-279816, and the like, it is known that, in the spray pyrolysis method, spherical powder having good crystallinity and uniform particle diameter is obtained. However, even if the carbon-compounded metal oxide power is produced by the spray pyrolysis method, then as mentioned above, the carbon in the vicinity of the surface of the powder particle is scattered and the carbon is unevenly distributed inside of the particle by the heating at the time of the thermal decomposition, and accordingly, it is difficult to form a homogeneous carbon film (surface carbon layer) on the surface of the metal oxide powder.

For this reason, in the production method of the present invention, the cathode material powder as a final product is not directly prepared, but first, a raw material solution containing the carbon source is turned into liquid droplets, and is thermally decomposed, whereby carbon-compounded metal oxide powder as intermediate powder is prepared. Here, it is not necessary that a carbon coating layer be formed on the intermediate powder; however, a particle diameter thereof must be larger than a particle diameter (“final particle diameter”) taken as a target in the cathode material powder as a final product. For example, in the case where the final particle diameter is set at 1 micrometer, then intermediate powder should be obtained a particle diameter (for example, several micrometers to several ten micrometers) larger than the final particle diameter. Such particle diameter control for the intermediate powder can be achieved by a publicly known method such as adjustment of a size of the liquid droplet, and of a concentration of the liquid droplets in the carrier gas.

Next, the obtained intermediate powder is milled so that the diameter thereof could be approximated to the final target particle diameter. By this milling, the carbon which is unevenly distributed in the inside of the intermediate powder comes to be present in the vicinity of the milled surface. It is accordingly believed that, by the annealing treatment which follows, the crystallinity is enhanced, and additionally the carbon present in the inside of milled particles is bumped out to a surface thereof together with crystal growth (crystal particle growth), and thereby the structure as mentioned above is formed. Thus, in accordance with the production method of the present invention, the cathode material having the structure shown in FIG. 6 and FIG. 7 can be formed easily and efficiently.

Note that, for the milling here, either the dry method or the wet method can be used, and for example, publicly known techniques such as the jet mill, the ball mill, the vibration mill, the attritor, and the beads mill can be used.

Moreover, the annealing treatment can be performed by either the continuous method or the batch method, and for example, can be performed by using the publicly known techniques such as the rotary kiln, the pusher kiln, the roller hearth kiln, the tunnel kiln, and the shuttle kiln. An annealing temperature and an annealing time are not particularly limited as long as the coating layer of carbon is formed in such a manner that the particles are grown; however, preferably, the annealing is performed, for example, at a peak temperature of 500 to 900 deg C. for 1 hour to 10 hours, more preferably, 600 to 800 deg C. for approximately 2 hours to 5 hours.

As a raw material compound usable in the production method of the present invention, any compound can be used as long as the compound is dissolvable as a mixed solution, and those described above can be used. For example, lithium nitrate, lithium chloride, lithium carbonate and the like can be used as the lithium-containing compound, and ethylene glycol, triethylene glycol, polyvinyl alcohol, glucose and the like can be used as the carbon-containing compound. Glucose is particularly preferable as the carbon-containing compound. Moreover, in response to a desired composition of the metal oxide, compounds containing cobalt, nickel, phosphorous, iron, manganese, tungsten, silicon, and boron can be appropriately selected and combined with one another.

### EXAMPLES

A description is more specifically made of the present invention by examples and comparative examples.

### Example 1

By using, as starting raw materials, lithium carbonate (Li₂CO₃), iron (II) oxalate dihydrate (FeC₂O₄.2H₂O), manganese carbonate (MnCO₃), silicon dioxide (SiO₂), ammonium dihydrogen phosphate (NH₄H₂PO₄) and boric acid (H₃BO₃), the respective metal oxide powders described in composition columns of Table 1 were prepared by the solid phase reaction method.

First, the respective raw materials were combined with one another and weighed so as to achieve composition ratios described in the composition columns of Table 1, and each of the mixtures thus obtained was subjected to the wet mixing for 72 hours in the ball mill by using methanol. In this regard, however, in the case of using boric acid, the dry mixing was performed. Each obtained mixture was fired at 800 deg C. for 16 hours under a nitrogen atmosphere, and thereafter, was milled by the planetary ball mill so that powder with a number average particle diameter of 0.5 micrometers could be finally obtained. Moreover, the milled powder was fired at 600 degrees for 24 hours under a nitrogen atmosphere, whereby metal oxide powders of Samples 1-1 to 1-20 were prepared.

Meanwhile, carbon materials, which were imparted with hydrophilicity by performing steam activation for carbon black and acetylene black, were prepared. In this event, a time of performing the steam activation is changed, whereby carbon materials different in amount of the hydrophilic functional groups were prepared.

Each of the metal oxide powders of Samples 1-1 to 1-18 prepared as described above was compounded by using the carbon black or acetylene black, which was imparted with the hydrophilicity, and each of the metal oxides of samples 1-19 and 1-20 was compounded by using carbon black or acetylene black, which was not imparted with the hydrophilicity. With regard to a compounding method of the carbon materials, each metal oxide powder and the carbon black or acetylene black were individually weighed so that a carbon content could have a value described in Table 1, and were subjected to the wet mixing for 72 hours by the ball mill using the methanol. An obtained mixture was fired at 400 deg C. for 5 hours under a nitrogen atmosphere, and thereafter, was subjected to analysis/measurement as follows.

The content of the carbon contained in each sample was measured by using a carbon/sulfur analyzer EMIA-320V of HORIBA, Ltd.

The composition of the metal oxide of each sample was subjected to composition analysis by using the inductively coupled plasma (ICP) emission spectroscopy ICPS-8100 of Shimadzu Corporation, and it was confirmed that all of the samples coincided with the compositions described in Table 1.

With regard to the carbon coating ratio, an SEM image of the metal oxide particle of each sample was observed by the already-described method, and image analysis was performed based on the image concerned, whereby a coating ratio of the carbon mass on the surface of the metal oxide particle was obtained. For the observation of the SEM image, JSM-7000F made by JEOL Ltd. was used. The SEM image was observed at an observation magnification of 10,000 to 50,000 powers in response to the particle diameter. In a picture having the observed SEM image, the coating ratio of the carbon mass on the metal oxide particle is obtained by image analysis software from the area of the metal oxide particle and the area of the carbon mass present on the surface concerned. Then, measurement was performed for 50 particles in a similar way, and an average thereamong was obtained.

The content ratio (percent) of the hydrophilic carbon was measured by the X-ray photoelectron spectroscopy by the already-described method. As a device, the X-ray photoelectron spectrometer ESCA-3400 made by Shimadzu Corporation was used.

For the measurement of the specific surface area and the fine-pore distribution, the automatic specific surface area/fine-pore distribution measurement device Tristar 3000 made by Shimadzu Corporation was used. The specific surface area was calculated by the BET (Brunauer, Emmett, Teller) method, and the fine-pore distribution was calculated by the BJH (Barrett, Joyner, Halenda) method. X-ray diffraction was measured by using the powder X-ray diffraction device Ultima II made by Rigaku Corporation.

With regard to the hydrophilicity of each prepared sample, a small amount (approximate 20 milligram) of powder of the sample was dropped into pure water (distilled water) in a test tube. As a result, in the case where a half or more of the powder was precipitated and dispersed into the water within 1 minute, it was determined that the sample was hydrophilic, and otherwise, it was determined that the sample was non-hydrophilic. In the column “dispersion to pure water” of Table 1, reference symbol “a” denotes that the sample is hydrophilic, and reference symbol “b” denotes that the sample is non-hydrophilic.

Evaluation of the battery property in the prepared sample was carried out in such a manner as follows.

Each prepared sample was used for the cathode, metal lithium was used as the anode, and the non-aqueous electrolytic solution was used, whereby a prototype battery was produced.

The cathode was produced in such a manner that the prepared sample powder was mixed with acetylene black powder and polytetrafluoroethylene powder in a weight ratio of 70:25:5, and an obtained mixture was kneaded in the mortar, and thereafter, was adhered with pressure to an aluminum mesh.

Metal lithium foil was used as the anode, and nickel foil of 20 micrometers was used as the anode collector.

As the electrolytic solution, a non-aqueous electrolytic solution was used, in which LiPF₆ of 1.0 mol/liter was dissolved into a mixed solvent of ethyl carbonate and dimethyl carbonate in a volume ratio of 1:2. As the separator, porous polypropylene with a thickness of 25 micrometers was used. By using these, a CR2032-type coin battery was assembled in an argon globe box.

Five batteries were produced for each of the samples, and were individually subjected to a charge/discharge test in a thermostat bath of 10 deg C., and discharge capacities thereof were measured. In the charge/discharge Lest, CC-CV measurement was performed at 0.15 C in a voltage range of 2.5 to 4.2 volt, 2.5 to 5.0 volt or 1.5 to 5.0 volt and the discharge capacities were measured. An average value of discharge capacities of three cells, which exclude those having maximum and minimum discharge capacities among such five cells, was obtained.

Table 1 shows evaluation results of the respective produced samples. With regard to a column of “discharge capacity” of Table 1, reference symbol “A” denotes that the discharge capacity was 80 percent or more of a theoretical capacity, reference symbol “B” denotes that the discharge capacity was less than 80 to 60 percent or more thereof, and reference symbol “C” denotes that the discharge capacity was less than 60 percent thereof.

TABLE 1

| | METAL OXIDE | | | | |
|---|---|---|---|---|---|
| | (ACTIVE MATERIAL) | | CARBON MATERIAL | | |
| | | HALF | | | CONTENT |
| | | WIDTH | | | RATIO |
| | | [DEGREE] | | CONTENT | [PERCENT]OF |
| | | OF | | [PERCENT | HYDROPHILIC |
| SAMPLE | COMPOSITION | XRD PEAK | TYPE | BY MASS] | CARBON |
| 1-1 | LiFePO₄ | 0.14 | STEAM-ACTIVATED CARBON BLACK | 8 | 35 |
| 1-2 | LiFePO₄ | 0.14 | STEAM-ACTIVATED ACETYLENE BLACK | 7.5 | 18 |
| 1-3 | LiFePO₄ | 0.14 | STEAM-ACTIVATED ACETYLENE BLACK | 1.5 | 25 |
| 1-4 | LiFePO₄ | 0.14 | STEAM-ACTIVATED ACETYLENE BLACK | 2.5 | 25 |
| 1-5 | LiFePO₄ | 0.14 | STEAM-ACTIVATED ACETYLENE BLACK | 7.5 | 25 |
| 1-6 | LiFePO₄ | 0.14 | STEAM-ACTIVATED ACETYLENE BLACK | 7.5 | 25 |
| 1-7 | LiFePO₄ | 0.14 | STEAM-ACTIVATED ACETYLENE BLACK | 7.5 | 25 |
| 1-8 | LiFePO₄ | 0.14 | STEAM-ACTIVATED ACETYLENE BLACK | 7.5 | 25 |
| 1-9 | LiFePO₄ | 0.14 | STEAM-ACTIVATED ACETYLENE BLACK | 11 | 25 |
| 1-10 | LiFePO₄ | 0.14 | STEAM-ACTIVATED ACETYLENE BLACK | 15 | 25 |
| 1-11 | LiFePO₄ | 0.14 | STEAM-ACTIVATED ACETYLENE BLACK | 18 | 25 |
| 1-12 | LiFePO₄ | 0.14 | STEAM-ACTIVATED ACETYLENE BLACK | 7.5 | 40 |
| 1-13 | LiFePO₄ | 0.14 | STEAM-ACTIVATED ACETYLENE BLACK | 7.5 | 45 |
| 1-14 | LiFePO₄ | 0.14 | STEAM-ACTIVATED ACETYLENE BLACK | 7.5 | 38 |
| 1-15 | Li(Mn_{0.9}Fe_{0.1})PO₄ | 0.25 | STEAM-ACTIVATED ACETYLENE BLACK | 6 | 33 |
| 1-16 | Li₂FeSiO₄ | 0.20 | STEAM-ACTIVATED ACETYLENE BLACK | 10 | 35 |
| 1-17 | Li₂MnSiO₄ | 0.15 | STEAM-ACTIVATED ACETYLENE BLACK | 10 | 35 |
| 1-18 | LiFeBO₄ | 0.18 | STEAM-ACTIVATED ACETYLENE BLACK | 9 | 35 |
| 1-19 | LiFePO₄ | 0.14 | CARBON BLACK | 8 | 0 |
| 1-20 | LiFePO₄ | 0.14 | ACETYLENE BLACK | 7.5 | 0 |

| | CARBON MATERIAL | | | | | |
|---|---|---|---|---|---|---|
| | | CONTENT RATIO | | | | |
| | | [PERCENT] OF | | | SPECIFIC | |
| | COATING | GRAPHITE | DISPERSION | FINE-PORE | SURFACE | |
| | RATIO | SKELTON | TO PURE | CAPACITY | AREA | DISCHARGE |
| SAMPLE | [PERCENT] | CARBON | WATER | [cm³/g] | [m²/g] | CAPACITY |
| 1-1 | 35 | 45 | a | 0.11 | 43 | A |
| 1-2 | 32 | 55 | a | 0.10 | 41 | B |
| 1-3 | 2 | 50 | a | 0.09 | 20 | B |
| 1-4 | 5 | 50 | a | 0.09 | 25 | A |
| 1-5 | 30 | 10 | a | 0.10 | 41 | B |
| 1-6 | 30 | 20 | a | 0.10 | 41 | A |
| 1-7 | 30 | 70 | a | 0.10 | 41 | A |
| 1-8 | 30 | 75 | a | 0.10 | 41 | B |
| 1-9 | 40 | 50 | a | 0.10 | 42 | A |
| 1-10 | 45 | 50 | a | 0.10 | 45 | A |
| 1-11 | 50 | 50 | a | 0.11 | 45 | B |
| 1-12 | 35 | 40 | a | 0.10 | 41 | A |
| 1-13 | 36 | 35 | a | 0.10 | 41 | B |
| 1-14 | 33 | 38 | a | 0.10 | 41 | A |
| 1-15 | 25 | 40 | a | 0.10 | 40 | A |
| 1-16 | 38 | 50 | a | 0.10 | 43 | A |
| 1-17 | 39 | 50 | a | 0.10 | 43 | A |
| 1-18 | 37 | 50 | a | 0.10 | 41 | A |
| 1-19 | 35 | 60 | b | 0.09 | 18 | C |
| 1-20 | 38 | 65 | b | 0.08 | 15 | C |

### Example 2

By using, as starting raw materials, lithium nitrate (LiNO₃), iron (III) nitrate nonahydrate (Fe(NO₃)₃.9H₂O), and phosphoric acid (H₃PO₄, 75 percent aqueous solution). LiFePO₄ metal oxide powder which contained the carbon material was prepared by combining the spray pyrolysis method, the milling and the heat treatment with one another. As a raw material of the carbon material to be contained, glucose was used.

First, the respective raw materials were weighed so as to achieve the composition ratio of LiFePO₄, and were dissolved into water at a concentration of 0.6 mol/liter. Into the aqueous solution, glucose was further dissolved so as to be 68 gram/liter. The aqueous solution thus prepared was sprayed by nitrogen carrier gas into a furnace heated up to 800 deg C., and was thermally decomposed, whereby intermediate powder was prepared. Moreover, wet milling using ethanol was performed for the intermediate powder so that powder with a number average particle diameter of 0.5 micrometers could be finally obtained, and thereafter, the intermediate powder was annealed at 700 deg C. for 2 hours in a nitrogen atmosphere.

An organization of the sample prepared as described above was observed by using a Transmission Electron Microscope (TEM: H-9000UHR III made by Hitachi, Ltd.). A surface carbon layer and a carbon mass, which are similar to those shown in FIG. 5, were observed. When the sample was subjected to mechanical polishing and ion milling and a cross section, thereof was observed by the TEM, a surface carbon layer and an internal carbon layer, which are similar to those shown in FIG. 6, were observed.

Moreover, when the coating ratio of the carbon mass on the surface carbon layer was measured by the SEM observation, the coating ratio was 25 percent.

The prepared sample was analyzed by respective analysis methods similar to those described in Example 1. As a result, in the prepared sample, a composition thereof coincided with that of LiFePO₄. The sample was dispersed into pure water, and in the sample, the half width of the XRD peak was 0.147 degrees, the carbon content was 8.1 percent by mass, the content ratio of the hydrophilic carbon was 21 percent, the content ratio of the graphite skeleton carbon was 38 percent, the fine-pore capacity was 0.28 cm³/g, the specific surface area was 89 m²/g, and the discharge capacity was 98 percent of the theoretical capacity.

The prepared sample of 95 percent by mass and PolyVinylidene DiFluoride (PVDF) of 5 percent by mass were mixed with a dispersion medium (N-methylpyrrolidone, NMP), and slurry was prepared. The slurry was applied on aluminum foil with a thickness of 20 micrometers by using a Baker-type applicator in which a clearance was set at 300 micrometers, and was dried by a dryer of 100 deg C., whereby a cathode was produced. Note that, in this event, acetylene black (conductive additive) was not used.

When the produced cathode was subjected to the charge/discharge test in a similar way to Example 1, then the charge and the discharge can be carried out, and a discharge capacity at this time was 97 percent of the theoretical capacity.

### Example 3

By using, as starting raw materials, lithium nitrate (LiNO₃), iron (III) nitrate nonahydrate (Fe(NO₃)₃.9H₂O), manganese nitrate hexahydrate (Mn(NO₃).6H₂O), and phosphoric acid (H₃PO₄, 75 percent aqueous solution), Li(Fe_{0.9}Mn_{0.1})PO₄ metal oxide powder, which contained the carbon material was prepared by combining the spray pyrolysis method, the milling and the heat treatment with one another. As a raw material of the carbon material to be contained, glucose was used.

First, the respective raw materials were weighed so as to achieve the composition ratio of Li(Fe_{0.9}Mn_{0.1})PO₄, and were dissolved into water at a concentration of 0.6 mol/liter. Into the aqueous solution, glucose was further dissolved so as to be 60 gram/liter. The aqueous solution thus prepared was sprayed by nitrogen carrier gas into a furnace heated up to 800 deg C., and was thermally decomposed, whereby intermediate powder was prepared. Moreover, wet milling using ethanol was performed for the intermediate powder so that powder with a number average particle diameter of 0.5 micrometers could be finally obtained, and thereafter, annealing was performed at 700 deg C. for 2 hours in a nitrogen atmosphere.

An organization of a sample prepared as described above was observed by using the TEM. A surface carbon layer and a carbon mass similar to those shown in FIG. 5 were observed. When the sample was subjected to mechanical polishing and ion milling, and a cross section thereof was observed by the TEM, a surface carbon layer and an internal carbon layer similar to those shown in FIG. 6 were observed.

Moreover, when the coating ratio of the carbon mass on the surface carbon layer was measured by the SEM observation, the coating ratio concerned was 25 percent.

The prepared sample was analyzed by respective analysis methods similar to those described in Example 1. As a result, in the prepared sample, a composition thereof coincided with that of Li(Fe_{0.9}Mn_{0.1})PO₄. The prepared sample was dispersed into pure water, and in the sample, the half width of the XRD peak was 0.18 degrees, the carbon content was 7.1 percent by mass, the proportion of the carbon having the hydrophilic functional group was 21 percent, the content ratio of the graphite skeleton carbon was 35 percent, the fine-pore capacity was 0.25 cm³/g, the specific surface area was 80 m²/g, and moreover, the discharge capacity was 95 percent of the theoretical capacity.

When the charge/discharge test was carried out in a similar way to Example 1 by using a cathode produced in a similar way to Example 2, then the charge and the discharge can be carried out, and a discharge capacity was 95 percent of the theoretical capacity.

As described above, even in the case where such derivative in which an element such as Mn was partially substituted for Fe was prepared as the metal oxide (active material), it was possible to obtain a high discharge capacity while a similar organization structure was being provided.

### Example 4

By using, as starting raw materials, lithium carbonate (Li₂CO₃), an iron and steel pickling waste liquid (hydrochloric acid waste liquid with a concentration 0.6 mol (Fe)/liter), and phosphoric acid (H₃PO₄, 75 percent aqueous solution), LiFePO₄ metal oxide powder which contained the carbon material was prepared by combining the baking method, the milling and the heat treatment with one another. As a raw material of the carbon material to be contained, fructose was used.

First, the respective raw materials were mixed with one another so as to achieve the composition ratio of LiFePO₄, and an aqueous solution with a concentration of 0.6 mol/liter was prepared. Into the aqueous solution, fructose was further dissolved so as to be 70 gram/liter. The aqueous solution thus prepared was introduced into a baking furnace of 800 deg C., and was thermally decomposed, whereby intermediate powder was prepared. Moreover, wet milling using water was performed for the intermediate powder so that powder with a number average particle diameter of 0.5 micrometers could be finally obtained, and thereafter, annealing was performed at 700 deg C. for 2 hours in a nitrogen atmosphere.

An organization of a sample prepared as described above was observed by using the TEM. A surface carbon layer and a carbon mass similar to those shown in FIG. 5 were observed. Moreover, when the sample was subjected to mechanical polishing and ion milling, and a cross section thereof was observed by the TEM, a surface carbon layer and an internal carbon layer similar to those shown in FIG. 6 were observed.

Moreover, when the coating ratio of the carbon mass on the surface carbon layer was measured by the SEM observation, the coating ratio concerned was 26 percent.

The prepared sample was analyzed by respective analysis methods similar to those described in Example 1. As a result, in the prepared sample, a composition thereof coincided with that of LiFePO₄. The prepared sample was dispersed into pure water, and in the sample, the half width of the XRD peak was 0.17 degrees, the carbon content was 9.1 percent by mass, the proportion of the carbon having the hydrophilic functional group was 22 percent, the content ratio of the graphite skeleton carbon was 36 percent, the fine-pore capacity was 0.27 cm³/g, the specific surface area was 82 m²/g, and the discharge capacity was 98 percent of the theoretical capacity.

When the charge discharge test was carried out in a similar way to Example 1 by using a cathode produced in a similar way to Example 2, then the charge and the discharge can be carried out, and a discharge capacity was 97 percent of the theoretical capacity.

### Example 5

By using, as starting raw materials, lithium nitrate (LiNO₃), iron (III) nitrate nonahydrate (Fe(NO)₃.9H₂O), and phosphoric acid (H₃PO₄, 75 percent aqueous solution), LiFePO₄ metal oxide powder which did not contain the carbon material was prepared by combining the spray pyrolysis method, the milling and the heat treatment with one another.

First, the respective raw materials were weighed so as to achieve the composition ratio of LiFePO₄, and were dissolved into water at a concentration of 0.6 mol/liter, and further, triethylene glycol was dissolved thereinto so as to be 50 gram/liter. Note that the triethylene glycol here is one, which is contained as a reducing agent which reduces trivalent iron to divalent iron in the event of the spray pyrolysis and does not remain as a carbon material. The aqueous solution thus prepared was sprayed by nitrogen carrier gas into a furnace heated up to 800 deg C., and was thermally decomposed, whereby intermediate powder was prepared. Moreover, wet milling using ethanol was performed for the intermediate powder so that powder with a number average particle diameter of 0.5 micrometers could be finally obtained, and thereafter, annealing was performed at 700 deg C. for 2 hours in a nitrogen atmosphere. The carbon content here was zero (equal to or less than a measurement lower limit value).

Moreover, the half width of the XRD peak was 0.15 degrees. When this sample was subjected to the charge/discharge test in a similar way to Example 1, the discharge capacity was 71 percent of the theoretical capacity since the carbon material was not contained.

Next, when the same steam-activated carbon black as Sample 1-1 of Example 1 was coated on this sample, then the discharge capacity became 82 percent of the theoretical capacity.

Note that, as a result of analyzing the sample, which was coated with the steam-activated carbon black, in a similar way to Example 1, the prepared sample was one, in which a composition coincided with that of LiFePO₄, and was one dispersed into pure water.

### Comparative Example 1

LiFePO₄ powder, which contained the carbon material was prepared in a similar way to Example 2 except that the milling and the annealing were not performed.

In the LiFePO₄ powder finally obtained, the number average particle diameter was 3 micrometers, and particles floating on a water surface of pure water without being sufficiently dispersed thereinto were present.

The half width of the XRD peak was 0.26 degrees, the proportion of the carbon having the hydrophilic functional group was 19 percent, the content ratio of the graphite skeleton carbon was 55 percent, the fine-pore capacity was 0.23 cm³/g, and the specific surface area was 30 m²/g.

The discharge capacity of the powder was 60 percent of the theoretical capacity. When the charge/discharge test was carried, out in a similar way to Example 1 by using a cathode produced in a similar way to Example 2, the charge/discharge was hardly done. Although the carbon material was contained by 8.2 percent by mass, the organization structure shown in FIG. 5 and/or FIG. 6 was not observed.

### Comparative Example 2

LiFePO₄ powder which contained, the carbon material was prepared in a similar way to Example 2 except that the milling was not performed.

The discharge capacity of the powder annealed at 600 deg C. for 2 hours in a nitrogen atmosphere without being milled was 60 percent of the theoretical capacity. When the charge/discharge test was carried out in a similar way to Example 1 by using a cathode produced in a similar way to Example 2, the charge/discharge was hardly done. Although the carbon material was contained by 8.1 percent by mass, the organization structure shown in FIG. 5 and/or FIG. 6 was not observed.

In the LiFePO₄ powder finally obtained, the number average particle diameter was 2.8 micrometers, and particles floating on a water surface of pure water without being sufficiently dispersed thereinto were present.

Moreover, the half width of the XRD peak was 0.24 degrees, the proportion of the carbon having the hydrophilic functional group was 19 percent, the content ratio of the graphite skeleton carbon was 50 percent, the fine-pore capacity was 0.15 cm³/g, and the specific surface area was 25 m²/g.

### Comparative Example 3

LiFePO₄ powder which contained the carbon material was prepared in a similar way to Example 2 except that the annealing was not performed.

The discharge capacity of the powder which was not annealed but was only milled was 65 percent of the theoretical capacity. When the charge/discharge test was carried out in a similar way to Example 1 by using a cathode produced in a similar way to Example 2, then the charge/discharge was done; however, the discharge capacity was 30 percent of the theoretical capacity. Although the carbon material was contained by 8.2 percent by mass, the organization structure shown in FIG. 5 and/or FIG. 6 was not observed.

In the LiFePO₄ powder finally obtained, the number average particle diameter was 0.05 micrometers, and particles floating on a water surface of pure water without being sufficiently dispersed thereinto were present.

Moreover, the half width of the XRD peak was 0.29 degrees, the proportion of the carbon having the hydrophilic functional group was 19 percent, the content ratio of the graphite skeleton carbon was 55 percent, the fine-pore capacity was 0.25 cm³/g, and the specific surface area was 31 m²/g.

### Comparative Example 4

By using, as starting raw materials, lithium nitrate (LiNO₃), iron (III) nitrate nonahydrate (Fe(NO₃)₃.9H₂O), and phosphoric acid (H₃PO₄, 75 percent aqueous solution), LiFePO₄ metal oxide powder was prepared by combining the spray pyrolysis method and the heat treatment with each other.

First, the respective raw materials were weighed so as to achieve the composition ratio of LiFePO₄, and were dissolved into water at a concentration of 0.5 mol/liter. Sucrose (saccharose) was added by 20 percent by mass into the aqueous solution, and was dissolved thereinto while being stirred. The aqueous solution prepared as described above was sprayed by air carrier gas into a furnace heated up to 800 deg C., and was thermally decomposed, and obtained intermediate powder was annealed at 700 deg C. for 2 hours in an argon-hydrogen (5 percent) mixed gas atmosphere.

In the LiFePO₄ powder finally obtained, the number average particle diameter was 3 micrometers, and particles floating on a water surface of pure water without being sufficiently dispersed thereinto were present.

Moreover, the half width of the XRD peak was 0.24 degrees, the proportion of the carbon having the hydrophilic functional group was 15 percent, the content ratio of the graphite skeleton carbon was 50 percent, the fine-pore capacity was 0.15 cm³/g, and the specific surface area was 25 m²/g.

1. A cathode material for a lithium ion secondary battery, comprising:
a metal oxide as a cathode active material; and
a carbon material which coats at least a part of a surface of a particle of the metal oxide,
wherein the cathode material has hydrophilicity so as to be precipitated into pure water.

2. The cathode material for the lithium ion secondary battery according to claim 1, wherein
at least a part of the carbon material is a carbon mass in which carbon becomes a bump-like form, and 5 percent or more to less than 50 percent of the surface of the particle of the metal oxide is coated with the carbon mass.

3. The cathode material for the lithium ion secondary battery according to claim 1, wherein
at least a part of the carbon material has a hydrophilic functional group, and a content ratio of the carbon material having the hydrophilic functional group with respect to a total amount of the carbon material which coats the surface of the particle of the metal oxide is 20 to 40 percent.

4. The cathode material for the lithium ion secondary battery according to claim 3, wherein
the hydrophilic functional group is a functional group containing oxygen (O).

5. The cathode material for the lithium ion secondary battery according to claim 3, wherein
a content ratio of a carbon material having a graphite skeleton is 20 to 70 percent with respect to the total amount of the carbon material which coats the surface of the particle of the metal oxide.

6. The cathode material for the lithium ion secondary battery according to claim 3, wherein
the content ratio V of the carbon material having the hydrophilic functional group is defined by a following formula (i):
V={(A−A_{SP2}−A_{SP3})/A}×100 (i)
where A is a peak area of C_{1S} measured by X-ray photoelectron spectroscopy of the carbon material, A_{SP2} is an SP² peak area occupying a part of the C_{1S} peak area, and A_{SP3} is an SP³ peak area occupying a part of the C_{1S} peak area.

7. The cathode material for the lithium ion secondary battery according to claim 1, wherein,
with regard to the metal oxide, a half width of a strongest diffraction peak in X-ray diffraction which takes Cu as a target is 0.2 degrees or less.

8. A cathode material for a lithium ion secondary battery, comprising:
a metal oxide particle as a cathode active material;
a surface carbon layer which coats at least a part of a surface of the metal oxide particle and is chemically bonded to the metal oxide; and
a bump-like carbon mass which coats a part of the surface of the metal oxide particle.

9. The cathode material for the lithium on secondary battery according to claim 8, further comprising:
an internal carbon layer to be bonded to the surface carbon layer, the internal carbon layer being provided in an inside of the metal oxide particle.

10. The cathode material for the lithium ion secondary battery according to claim 8, wherein
a thickness of the surface carbon layer is 2 nanometers or more to 10 nanometers or less.

11. The cathode material for the lithium ion secondary battery according to claim 8, wherein
a coating ratio of the carbon mass with respect to the surface of the metal oxide particle is 5 percent or more to less than 50 percent.

12. A method for producing a cathode material for a lithium ion secondary battery, comprising the steps of:
turning a mixed solution into a liquid droplet, the mixed solution containing at least a lithium-containing compound and a carbon-containing compound;
thermally decomposing the liquid droplet to generate an intermediate powder; and
milling the intermediate powder; and
annealing the milled intermediate powder, wherein
the cathode material for the lithium ion secondary battery, in which at least a part of a surface is coated with a carbon material, is produced by the steps.

13. The producing method according to claim 12, wherein
the carbon-containing compound is at least one of ethylene glycol, triethylene glycol, polyvinyl alcohol, and glucose.
